(19) United States
(12) Patent Application Publication
(10) Pub. No.: US 2017/0120665 A1
(43) Pub. Date: May 4, 2017

(54) DISK-BOUND SCRAPBOOK SYSTEMS WITH COVERED SPINE

(71) Applicant: Continental Accessory Corporation, Amityville, NY (US)

(72) Inventors: Ronald Koeppel, Brookville, NY (US); Richard P. Koeppel, Brookville, NY (US)

(21) Appl. No.: 15/404,638

(22) Filed: Jan. 12, 2017

Related U.S. Application Data
(63) Continuation-in-part of application No. 15/164,112, filed on May 25, 2016.
(60) Provisional application No. 62/170,884, filed on Jun. 4, 2015.

(51) Int. Cl. B42F 5/00; B42F 13/12; B42F 3/00

(52) U.S. Cl. CPC B42F 5/00; B42F 3/003; B42F 13/12

(57) ABSTRACT

A scrapbook system is disclosed. The scrapbook system includes a pair of covers an intermediate panel connecting the pair of pivotable covers, a stack of plural pages and a plurality of disks releasably mounting the pages on the disks between the covers. Each of the disks is circular and has a generally planar central section and an enlarged peripheral rim. The covers are pivotally connected to each other by an intermediate member. The disks are concealed from the outside of the scrapbook system when the covers are closed by means of a cover. At least some of the pages include at least one pocket for receipt of a keepsake item, with portions of at least some of the pages being transparent to enable one to view a keepsake item located in the pocket through the transparent portion of the page.

### CROSS-REFERENCE TO RELATED APPLICATIONS

This application is a Continuation-In-Part of prior application Ser. No. 15/164,112 filed on May 25, 2016, entitled Disk-Bound Scrapbook System, which in turn claims priority from Provisional Application 62/170,884, filed on Jun. 4, 2015, entitled Disk-Bound Scrapbook System, the entire disclosure of both applications are hereby incorporated by reference herein.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISK

Not Applicable

### FIELD OF THE INVENTION

This invention relates generally to scrapbook systems with removable pages and more particularly to scrapbook systems whose removable pages are held within a cover having a permanent spine via plural disks mounted in the spine.

### BACKGROUND OF THE INVENTION

Notebook systems making use of a stack of sheets is bound together using a plurality of disks are commercially available from various sources, including Continental Accessory, Corp., the assignee of the subject invention. Those notebook systems include a separate front cover, a separate rear cover, a plurality of disks and a stack of sheets, e.g., paper sheets. Each of the sheets and the covers include a plurality of mushroom-like shaped slots along one marginal edge thereof. Each of the slots is arranged to receive a respective disk to bind all of the sheets and covers together, so that the notebook serves as a binder with removable sheets. Some of the foregoing systems can be configured for usage as scrapbooks. To that end, such systems make use of pages which have at least one pocket therein for accepting and holding a keepsake item, a photograph, a card, a letter, stamps, etc.

U.S. Pat. No. 5,553,959 (Feldman et al.) and U.S. Pat. No. 5,749,667 (Feldman et al.) disclose notebook systems like the foregoing. In particular, the Feldman et al. systems make use of a stack of sheets is bound together between a front and rear cover using a plurality of disks that are inserted into mushroom shaped slots in the edge of each of the sheets of the stack and each of the covers. Each of the plural disks has a substantially flat disk-like central surface portion and an enlarged continuous rim portion which extends around the periphery of the central surface portion. The rim portion extends outwardly in a direction perpendicular to the flat central portions of the disks, and the central surface portion has a radius which is larger than the thickness of a stack of sheets to be bound thereby.

While such prior art notebook or scrapbook systems are generally suitable for their intended purposes, the fact that the disks serves to secure the cover panels together, leaves them susceptible to accidental disconnection. Moreover, such systems leave something to be desired from the standpoint of aesthetics due to the manner in which the cover panels are connected together by the disks. Thus, a need exists for a disk bound scrapbook system which is resistant to accidental disconnection of the disks from the cover panels and which is aesthetically pleasing in appearance. The subject invention addresses those needs.

All references cited and/or identified herein are specifically incorporated by reference herein.

### SUMMARY OF THE INVENTION

In accordance with one aspect of this invention a scrapbook system is provided. The scrapbook system comprises a cover assembly, a plurality of disks, and a plurality of pages. Each of the disks is circular and has a generally planar central section having a predetermined thickness and an enlarged peripheral rim extending about the central section. The cover assembly comprises a pair of cover panels, a spine and a spine cover. Each of the cover panels includes an edge portion. The spine comprises a plurality of spaced-apart slots. The spine is fixedly secured to respective edge portions of the cover panels. Each of the slots of the spine comprises a generally linear section and a pair of bulbous end sections located on respective ends of the linear section. The disks are located in respective ones of the slots of the spine. Each of the pages comprises a web of material having an inner edge and a plurality of slots spaced along the inner edge. Each of the slots of each of the pages comprises an entryway channel extending inward from the inner edge and terminating at an enlarged opening for receipt of the enlarged peripheral rim and contiguous planar central section of a respective one of the plurality of disks. The spine cover is disposed over the central section of the spine. The edge portions of the cover panels are fixedly secured to the spine and the spine cover.

In accordance with another aspect of this invention, the spine cover comprises an inner surface and a pair of side edges and wherein the edge portions of the cover panels are pivotably connected to respective side edges of the spine cover by a hinge line to enable the cover panels to pivot with respect to the central section of said spine cover.

In accordance with another aspect of this invention, the spine is fixedly secured on said inner surface of said spine cover.

In accordance with another aspect of this invention, each of the cover panels includes an edge portion and the spine comprises a generally U-shaped member having a central section and a pair of edge sections. The slots are located in the central section. The edge sections are located on opposite sides of the central section and each is fixedly secured to a respective edge portion of a respective one of the cover panels. The spine cover comprises a generally U-shaped member having a central section and a pair of edge sections. The central section of the spine cover is disposed over the central section of the spine. The edge sections are located on opposite sides of the central section of the spine cover and fixedly secured to respective edge portions of the cover panels.

In accordance with another aspect of this invention, each of the edge sections of the spine is connected to the central section of the spine by a hinge line to enable the edge sections to pivot with respect to the central section.

In accordance with another aspect of this invention each page of the scrapbook system comprises at least one pocket therein for receipt of a keepsake item.

### DESCRIPTION OF THE DRAWING

FIG. 1 is an isometric view of one exemplary embodiment of a disk-bound scrapbook system constructed in accordance with this invention, wherein the system includes plural disks for releasably holding the pages of the scrapbook;

FIG. 2 is an isometric view showing the exemplary embodiment of the scrapbook system of FIG. 1, but with the front cover opened (e.g., folded back) to expose the stack of pages of the scrapbook system;

FIG. 3 is plan view of one exemplary embodiment of a page of the disk-bound scrapbook system shown in FIGS. 1 and 2;

FIG. 4 is an enlarged plan view of the portion of the page shown within the broken circle designed by the reference number 4 in FIG. 3;

FIG. 5 is an enlarged sectional view taken along line 5-5 of FIG. 3;

FIG. 6 is an enlarged front elevation view of a portion of the spine of the scrapbook system shown in FIGS. 1 and 2;

FIG. 7 is an isometric view of another exemplary embodiment of a scrapbook system in accordance with this invention, which system includes a cover over the plural disks to hide them;

FIG. 8 is an enlarged sectional view taken along line 8-8 of FIG. 7;

FIG. 9 is an isometric view showing the exemplary embodiment of the scrapbook system of FIG. 7, but with the front cover opened (e.g., folded back) to expose the stack of pages of the scrapbook system;

FIG. 10 is an isometric view of still another exemplary embodiment of a scrapbook system in accordance with this invention wherein the system includes a cover over the plural disks to hide them:

FIG. 11 is an enlarged sectional view taken along line 10-10 of FIG. 10;

FIG. 12 is an isometric view of still another exemplary embodiment of a scrapbook system in accordance with this invention wherein the system includes a cover over the plural disks to hide them and wherein the disks are interconnected as a unitary member; and

FIG. 13 is an enlarged isometric view taken from the underside of the embodiment of FIG. 2 showing how the unitary disk assembly is secured to cover of the scrapbook system.

### DETAILED DESCRIPTION OF THE PREFERRED EMBODIMENT

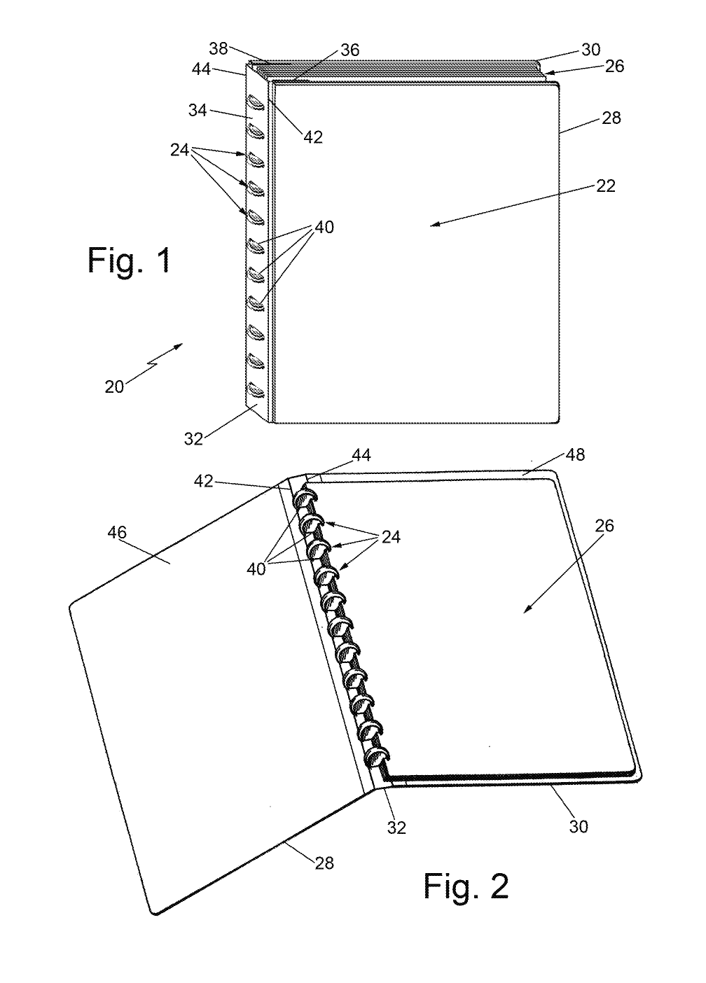

Referring now to the various figures of the drawing wherein like reference characters refer to like parts, there is shown at 20 in FIG. 1 one exemplary embodiment of a scrapbook system 20 constructed in accordance with this invention.

The scrapbook basically comprises a cover assembly 22, a plurality of disks 24 and a plurality of pages 26. The cover assembly includes a front or top cover member or panel 28, a bottom or rear cover member or panel 30, and an intermediate panel forming a spine 32. The cover members are each generally planar members formed of any suitable material, e.g., cardboard, leather, polypropylene, polyvinyl chloride, polyurethane, etc. The spine 32 is a generally U-shaped member formed of any suitable material, e.g., cardboard, leather, polypropylene, polyvinyl chloride, polyurethane, metal, etc. The intermediate panel 32 has a central section 34 and a pair of edge sections 36 and 38. The central section is of a predetermined width and includes a plurality of equidistantly spaced-apart slots 40 extending along the length of the spine. The edge sections 36 and 38 are located on opposite sides of the central section 34 by respective hinge lines 42 and 44 to enable each edge section to pivot with respect to the central section 34 along its respective hinge line. The edge section 36 is fixedly secured to the inner surface of the front cover panel 28 by any suitable means, e.g., an adhesive (not shown). In a similar manner, the edge section 38 is fixedly secured to the inner surface of the rear cover panel 30 by any suitable means, e.g., an adhesive (not shown). Thus the intermediate panel or spine pivotally connects the front and rear cover panels together, while enabling them to be pivoted about their respective hinge lines to enable the cover panels to be in a closed position, like shown in FIG. 1, or an open position, like shown in FIG. 2.

In the interest of aesthetics, a liner sheet 46 is adhesively secured on the inner surface of the front cover panel 28 with the edge section 36 of the spine interposed therebetween to hide it as can be seen in FIG. 2. In a similar manner, a liner sheet 48 is adhesively secured on the inner surface of the rear cover panel 30 with the edge section 38 of the spine interposed therebetween to hide it.

Turning now to FIG. 6, the details of the slots 40 in the spine will now be described. Thus, as can be seen each slot 40 basically comprises a linear central channel 40A which extends perpendicularly to the longitudinal axis of the spine, i.e., the channel extends transversely. The channel 40 includes an opposed pair of ends, each of which is in the form of an enlarged opening 40B. Each opening is somewhat mushroom-like in shape, with the outer edge 40C of the enlarged opening 40B being linear.

As mentioned above each of the disks 24 is arranged to be received in a respective slot 40. Thus, the disks 24 are circular and are of a cross-section which is shaped to mate with the slots 40. In particular, the periphery of each disk comprises an enlarged continuous rim portion extending around the entire periphery of the disk member, with the rim portion having shape corresponding to the shape of the openings 40B of the slot 40. The central section of each disk is planar and is of a thickness slightly less than the width of the channel 40A so that it can be received within the channel, when portions of the rim of the disk are within the enlarged openings 40B.

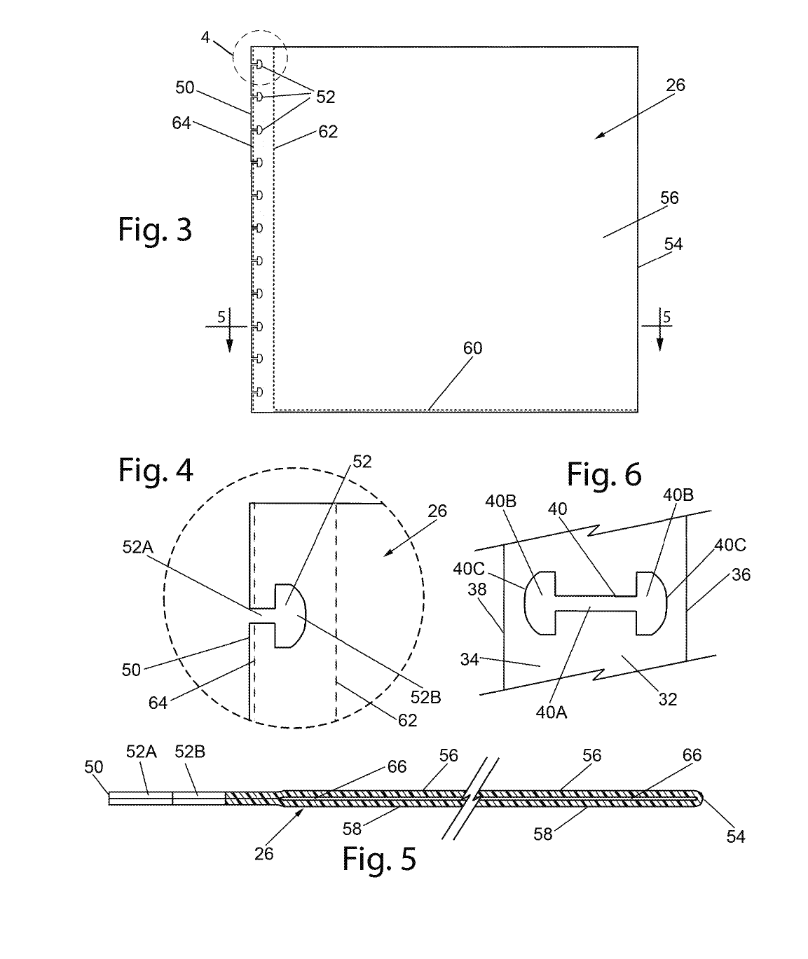

As mentioned earlier the disks 24 serve to releasably mount the pages 26 to the spine and between the cover panels. To that end, as best seen in FIGS. 3 and 4, each page 26 is includes a marginal edge portion 50 having a plurality of generally mushroom-like shaped slots 52 equidistantly located therealong to receive a respective one of the plurality of disks 24 therein. The slots 52 are best seen in FIG. 4 and basically each comprises one half of the slot 40 described earlier. To that end, each slot 52 includes an entryway or channel 52A which extends inward from the edge 50 of the page 26 and is perpendicular to that edge. Each channel 52A terminates at an enlarged opening 52B which is identical to the opening 40B. Thus a portion of the rim of the disk 24 can be located within the enlarged opening 52B, while the contiguous central portion of the disk is located within the channel 52A.

In accordance with a preferred embodiment of this invention at least some of the pages of the stack of pages of the system are constructed to include a pocket for holding a keepsake item. In the exemplary embodiment shown all of the pages 26 are so constructed. Moreover, the pages are preferably transparent (or at least include transparent portions contiguous with the pocket) to enable the keepsake item within the pocket to be readily viewed through the transparent portion of the page. However, it is contemplated that the pages can be paper or some other opaque material, if it is not desired to see the item held as a keepsake.

In the exemplary embodiment shown in FIGS. 3 and 5 each page basically comprises a sheet or web of a transparent plastic material which is folded into half along an outer marginal edge 54 to form a top sheet 56 and a bottom sheet 58. The lower edge of the top sheet and bottom sheet are secured, e.g., welded, together along a bottom seal line 60. A portion of the top and bottom sheet closely adjacent the slots 52 are secured, e.g., welded, together along an intermediate seal line 62. The portions of the top sheet and the bottom sheet immediately adjacent the edge 50 are also secured, e.g., welded, together along a edge seal line 64. This arrangement forms a hollow pocket 66 between the top sheet and the bottom sheet. The top edges of the top sheet and the bottom sheet are not secured together to provide an entryway or mouth for the pocket 66, through which a keepsake item can be introduced into the pocket.

By virtue of the fact that the page 26 is of double thickness and secured together by the seal lines 62 and 64, the inner edge of the page in which the slots 54 are located is reinforced. This ensures that the sheet is resistant to damage when it is inserted into the scrapbook or removed from the scrapbook.

As mentioned earlier, the page is preferably formed of a plastic material that is transparent. However, it could be opaque and/or colored in the interest of aesthetics.

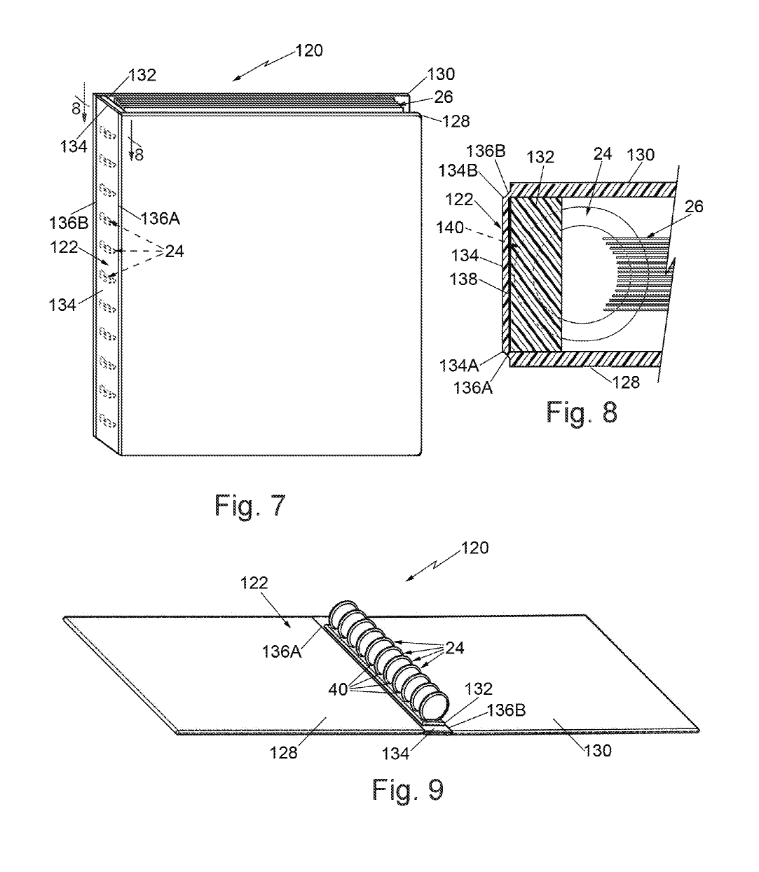

Turning now to FIGS. 7-9 there is shown another exemplary embodiment of a scrapbook system 120 constructed in accordance with this invention. The system 120 is similar in many respects to the system 20 except that it is constructed so that the plural disks of the spine are covered by a spine cover in order to hide them. In the interest of brevity the features of the system 120 which are the same as the features of the system 20 will be given the same reference numbers and the details of their construction and operation will not be reiterated.

Thus as can be seen in FIGS. 7-9 the system 120 basically comprises a cover assembly 122, a plurality of disks 24 and a plurality of pages 26. The cover assembly 122 includes a front or top cover member or panel 128, a bottom or rear cover member or panel 130, a spine 132 and an intermediate member or panel 134. The intermediate panel serves as a spine cover. The cover members 128 and 130 and the spine cover 134 are each generally planar members formed of any suitable material, e.g., cardboard, leather, polypropylene, polyvinyl chloride, polyurethane, metal, etc., and preferably are in the form of an integral or unitary member, but may be separate components. The cover members 128 and 130 are pivotally connected to opposite sides 134A and 134B of the spine cover by hinge lines 136A and 136b, respectively. The hinge lines can be in any form, e.g., flexible joint or a living hinge of a unitary member, so that the cover members 128 and 130 can pivot with respect to the spine cover 134. Thus the spine connects the front and rear cover panels together, while enabling them to be pivoted about their respective hinge lines to enable the cover panels to be closed, like shown in FIGS. 7 and 8, or opened, like shown in FIG. 9.

The spine 132 is a generally planar member in the form of a block which is thicker than the cover members. The block is fixedly secured on the inner surface of the spine cover 134 by any suitable means, e.g., an adhesive 138 (FIG. 8). The spine may be formed of any suitable material, e.g., polypropylene, polyvinyl chloride, polyurethane, cardboard, leather, metal, etc. In fact, the spine may be integral with the spine cover, e.g., formed as a unitary member. In any case, the spine includes a plurality of equidistantly spaced-apart slots 140 extending along the length of the spine and into the body of the spine, as best seen in FIGS. 8 and 9. Each slot 140 is a female member that is shaped to mate with (closely receive) a peripheral portion of any of the disks 24, whereupon when the disks are mounted in the slots portions of the disks project upward and outward from the top surface 132A of the spine as shown in FIG. 9. This enables the disks to releasably mount the pages 26 to the spine 132 and between the cover panels as shown in FIG. 8.

Since the spine 132 is mounted on the inner surface of the spine cover 134, the spine cover conceals the portions of the disks 24 which project into the slots 140 of the spine. Those concealed portions of the disks 24 are shown by the broken or dotted lines in FIGS. 7 and 8. While in most cases the spine cover 134 will be opaque, it is contemplated that the spine cover be transparent or translucent or to have a transparent or translucent portion, e.g., a window, to enable the disks 14 to be seen from the outside of the scrapbook system, if that is desired.

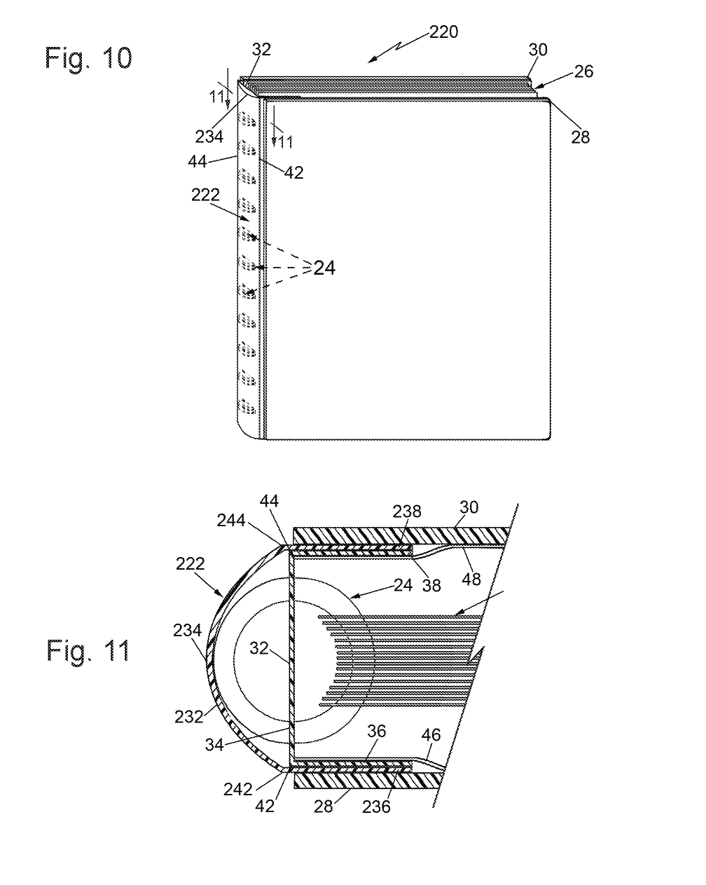

Turning now to FIGS. 10-11 there is shown another exemplary embodiment of a scrapbook system 220 constructed in accordance with this invention. The system 120 is similar in many respects to the system 120 in that the plural disks of the spine are covered by a spine cover in order to hide them. Moreover, the system 220 includes many of the same components as the system 20. Thus, in the interest of brevity the features of the system 220 which are the same as the features of the system 120 and the system 20 will be given the same reference numbers and the details of their construction and operation will not be reiterated.

The system 220 basically comprises a cover assembly 222, a plurality of disks 24 and a plurality of pages 26. The cover assembly 222 includes a front or top cover member or panel 28, a bottom or rear cover member or panel 30, a spine 32, and an intermediate member or panel 232. The intermediate panel 232 serves as a spine cover. The cover members 28 and 30 are each generally planar members formed of any suitable material, e.g., cardboard, leather, polypropylene, polyvinyl chloride, polyurethane, metal, etc.

The spine 32 pivotally connects the front and rear cover panel 28 and 30, respectively, to opposite sides of the spine, thereby enabling them to be pivoted about their respective hinge lines 42 and 44 to enable the cover panels to be closed, like shown in FIGS. 10 and 11, or opened (not shown).

As best seen in FIG. 11, the spine cover 232 is a generally U-shaped member formed of any suitable material, e.g., cardboard, leather, polypropylene, polyvinyl chloride, polyurethane, etc., and is preferably it is the same material as the cover panels 28 and 20, but may be a different material Preferably the spine cover 232 is flexible. The spine cover 232 has a central section 234 and a pair of edge sections 236 and 238. The central section, being flexible, can bend into an arcuate shape like shown in FIG. 10 when the spine cover is disposed over the spine, as will be described shortly. The edge sections 236 and 238 are located on opposite sides of the central section 234 by respective hinge lines 242 and 244. Those hinge lines are the result of the flexible nature of the spine cover. It is contemplated that the spine cover is a rigid member. In that case the central section will be arcuate in shape to accommodate the projecting portions of the disks 24, and the hinge lines will be formed in any suitable manner. In any case, the hinge lines enable each edge section 236 and 238 to pivot with respect to the central section 234.

The edge section 236 of the spine cover 232 is fixedly secured by any suitable means, e.g., an adhesive (not shown), to the inner surface of the edge section 36 of the spine, which in turn is fixedly secured to the front cover panel 28. In a similar manner, the edge section 238 is fixedly secured by any suitable means, e.g., an adhesive (not shown), to the inner surface of the edge section 28 of the spine, which in turn is fixedly secured to the rear cover panel 30. Thus the spine cover 234 in cooperation with the spine 32 pivotally connects the front and rear cover panels together, thus enabling them to be pivoted about their respective hinge lines to enable the cover panels to be closed or opened.

Since the spine cover 232 is mounted over the spine 32, it conceals the portions of the disks 24 which project outside of the spine. Those concealed portions of the disks 24 are shown by the broken or dotted lines in FIG. 10. While in most cases the spine cover 232 will be opaque, it is contemplated that the spine cover be transparent or translucent or to have a transparent or translucent portion, e.g., a window, to enable the disks 14 to be seen from the outside of the scrapbook system, if such is desired.

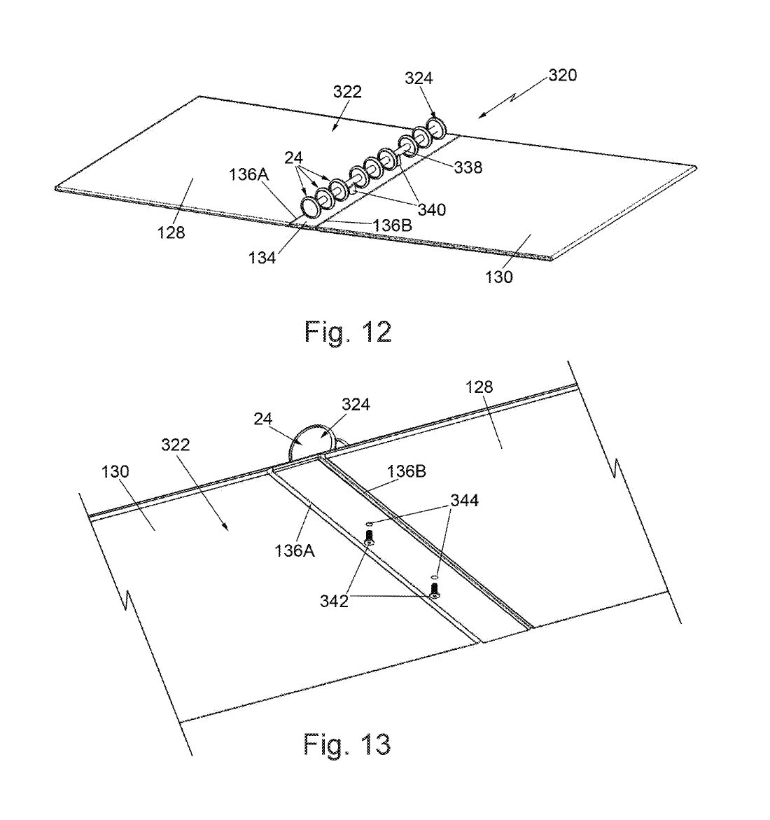

Turning now to FIGS. 12-13 there is shown another exemplary embodiment of a scrapbook system 320 constructed in accordance with this invention. The system 320 is similar in many respects to the system 120 in that it includes plural disks for releasably mounting pages thereon, which disks are hidden. Moreover, the system 320 includes a cover assembly that is similar in construction to portions of the cover assembly of scrapbook systems 20 and 120. Thus, in the interest of brevity the features of the system 320 which are the same as the features of the system 120 and the system 20 will be given the same reference numbers and the details of their construction and operation will not be reiterated.

As can be seen in FIG. 12 the system 320 basically comprises a cover assembly 322, a disk assembly 324 including plurality of disks, and a plurality of pages (not shown but like the pages 26 described heretofore). The cover assembly 322 includes a front or top cover member or panel 128, a bottom or rear cover member or panel 130, and an intermediate panel 134 pivotally connecting the cover panels 128 and 130 on opposite sides thereof via respective hinge lines 136A and 136B. As will be appreciated by those skilled in the art from the discussion to follow the intermediate panel 134 serves to hide or conceal the disk assembly 324 from the outside of the scrapbook system 320 in a manner similar to that provided by the spine cover 134 of the scrapbook system 120. The disk assembly 324 is similar in construction to what is referred to as the spine of U.S. Pat. No. 9,428,000 (Koeppel et al.), which is assigned to the same assignee as this application and whose disclosure is incorporated by reference herein. The disk assembly 324 is a unitary member, formed of any suitable material, e.g., a strong plastic, metal, etc., and is made up of a plurality of disks 24 which are fixedly secured to each other by a common central bar or rod 338. Each disk 24 is shaped to be received within a correspondingly shaped slot in the edge of each page 26. The disk assembly also includes plural, in this case two, arm-like projections 340 projecting perpendicularly to the central longitudinal axis of the central rod 338. Each projection 340 includes a bottom free end (not shown) that is hollow and configured to receive a respective one of a pair of fasteners 342 (FIG. 13) therein to secure the disk assembly 324 onto the inner surface of the intermediate panel 332. To that end, the intermediate panel 332 includes a pair of openings 344 which are configured to receive respective ones of the fasteners 342 therethrough. The extending or free end portions of the fasteners can then be introduced into the hollow free end of respective ones of the projections 340 of the disk assembly 324 to mount the disk assembly onto the inner surface of the intermediate panel 332 of the cover assembly 322. The fasteners 342 can be of any suitable type, e.g., threaded fasteners, in which case the hollow interior of each projection 340 at its free end will be correspondingly threaded to enable the fastener to be screwed therein. Other types of fasteners, whether releasably like a screw, or permanent like a rivet, can be used in this invention.

Since the intermediate panel 134 is mounted over the disk assembly 324, it conceals that assembly from being seen when the covers are closed. While in most cases the intermediate panel 134 will be opaque, it is contemplated that it may be transparent or translucent or to have a transparent or translucent portion, e.g., a window, to enable the disk assembly 324 to be seen from the outside of the scrapbook system, if such is desired.

It should be appreciated by those skilled in the art that various modifications can be made to the scrapbook systems of this invention. Thus, the exemplary embodiments shown and described above are just that, i.e., exemplary.

Without further elaboration the foregoing will so fully illustrate my invention that others may, by applying current or future knowledge, adopt the same for use under various conditions of service.

We claim:

1. A scrapbook system comprising a cover assembly, a plurality of disks, and a plurality of pages, each of said disks being circular and having a generally planar central section having a predetermined thickness and an enlarged peripheral rim extending about said central section, said cover assembly comprises a pair of cover panels, and an intermediate panel disposed between said cover panels and pivotally connecting said cover panels to said intermediate panel, whereupon said cover panel can be pivoted between a closed and an open position, each of said pages comprising a web of material having an inner edge and a plurality of slots spaced along said inner edge, each of said slots of each of said pages comprising an entryway channel extending inward from said inner edge and terminating at an enlarged opening for receipt of said enlarged peripheral rim and contiguous planar central section of a respective one of said plurality of disks, said intermediate panel having an inner surface, said disks being mounted on said inner surface, whereupon when said cover panels are pivoted to the closed position the intermediate panels conceals said disk from view.

2. The scrap book system of claim 1 wherein said cover assembly additionally comprises a spine and wherein said intermediate panel forms a spine cover, wherein each of said cover panels includes an edge portion, wherein said spine comprises a plurality of spaced-apart slots, with said spine being connected to respective edge portions of said cover panels, and with each of said slots of said spine comprising a generally linear section and a pair of bulbous end sections located on respective ends of said linear section, said disks being located in respective ones of said slots of said spine, said spine cover being disposed over said central section of said spine.

3. The scrapbook system of claim 2 wherein said spine cover comprises an inner surface and a pair of side edges and wherein said edge portions of said cover panels are pivotably connected to respective side edges of said spine cover by a hinge line to enable said cover panels to pivot with respect to said central section of said spine cover.

4. The scrapbook system of claim 3 wherein said spine is fixedly secured on said inner surface of said spine cover.

5. The scrapbook system of claim 2 wherein said spine comprises a generally U-shaped member having a central section and a pair of edge sections, said slots being located in said central section, said spine cover comprising a generally U-shaped member having a central section and a pair of edge sections, said edge sections of said spine cover being fixedly secured to respective edge portions of said cover panels, said central section of said spine cover being disposed over said central section of said spine, said edge sections of said spine cover being located on opposite sides of said central section of said spine cover and fixedly secured to respective edge sections of said spine.

6. The scrapbook system of claim 5 wherein each of said edge sections of said spine is connected to said central section of said spine by a hinge line to enable said edge sections to pivot with respect to said central section

7. The scrapbook system of claim 2 wherein said central section of said spine cover is opaque, whereupon said spine cover conceals said disks from being viewed from the outside of said scrapbook system.

8. The scrapbook system of claim 5 wherein said central section of said spine cover is opaque, whereupon said spine cover conceals said disks from being viewed from the outside of said scrapbook system.

9. The scrapbook system of claim 2 wherein at least some of said pages of said scrapbook system comprise at least one pocket therein for receipt of a keepsake item.

10. The scrapbook system of claim 5 wherein at least some of said pages of said scrapbook system comprise at least one pocket therein for receipt of a keepsake item.

11. The scrapbook system of claim 9 wherein at least some of said pages of said scrapbook system include at least one transparent portion located at said at least one pocket to enable the keepsake item located within said pocket to be viewed while in said pocket.

12. The scrapbook system of claim 10 wherein at least some of said pages of said scrapbook system include at least one transparent portion located at said at least one pocket to enable the keepsake item located within said pocket to be viewed while in said pocket.

13. The scrapbook system of claim 5 additionally comprising a pair of liner sheets, one of said liner sheets being secured to one of said pair of cover panels, with a one of said edge sections of said spine and one of said edge sections of said spine cover interposed between said one of said pair of cover panels and said one of said pair of liner sheets, with the other of said pair of liner sheets being secured to the other of said pair of cover panels, with the other of said edge sections of said spine and the other of said edge sections of said spine cover interposed between said other of said pair of cover panels and said other of said pair of liner sheets.

14. The scrapbook system of claim 1 wherein said plurality of disks forms a portion of a disk assembly, said disk assembly additionally comprising a common bar fixedly securing said disks to each other.
